(19) United States
(12) Patent Application Publication
(10) Pub. No.: US 2013/0266319 A1
(43) Pub. Date: Oct. 10, 2013

(54) Photonic Antenna

(71) Applicants: Patricia Bodan, Amherst, NH (US); John T. Apostolos, Lyndeborough, NH (US); William Mouyos, Windham, NH (US); Benjamin McMahon, Keene, NH (US)

(72) Inventors: Patricia Bodan, Amherst, NH (US); John T. Apostolos, Lyndeborough, NH (US); William Mouyos, Windham, NH (US); Benjamin McMahon, Keene, NH (US)

(73) Assignee: AMI Research & Development, LLC, Windham, NH (US)

(21) Appl. No.: 13/536,227

(22) Filed: Jun. 28, 2012

Related U.S. Application Data
(63) Continuation-in-part of application No. 13/372,117, filed on Feb. 13, 2012.
Application No. 13/372,117 is a continuation-in-part of application No. 13/357,448, filed on Jan. 24, 2012.
(60) Provisional application No. 61/441,720, filed on Feb. 11, 2011.
(60) Provisional application No. 61/502,260, filed on Jun. 28, 2011.
(60) Provisional application No. 61/502,259, filed on Jun. 28, 2011.

(51) Int. Cl. G02B 6/00; H04J 14/02; H04B 10/10

(52) U.S. Cl. 398/79; 359/599; 398/139; 398/142

(57) ABSTRACT

A photonic antenna uses a traveling wave fed, surface wave excited, dielectric waveguide. One or more antenna elements are arranged in a line or other array. An optical interconnect is provide by depositing the waveguide structure on the system of antenna elements, and the photodiode detectors on the waveguide, or wafer bonded to the waveguide core. Optical sources are butt coupled to the edge of the waveguide via wafer bonding or as part of a deposition process. The device acts as a free-space optical transceiver embodied in an integrated photonic antenna and waveguide structure, and provides high speed, spectrally broadband response; it also inherently includes an open architecture for implementing Wavelength Division Multiplexing (WDM).

### RELATED APPLICATION(S)

This application claims the benefit of U.S. Provisional Application No. 61/502,259 filed on Jun. 28, 2011 (Attorney Docket No. 4696.1009-000) and is a continuation-in-part of U.S. application Ser. No. 13/372,117 filed Feb. 13, 2012 (Attorney Docket No. 4694.1010-001) which itself claimed priority to U.S. Provisional Application No. 61/441,720, filed on Feb. 11, 2011, U.S. Provisional Application No. 61/502,260 filed on Jun. 28, 2011 and is a continuation-in-part of U.S. application Ser. No. 13/357,448, filed Jan. 24, 2012.

The entire teachings of the above application(s) are incorporated herein by reference.

### TECHNICAL FIELD

The present disclosure relates to a photonic antenna solution that can be used as part of an optical transmission and detection system.

### BACKGROUND

High speed optical interconnects have been sought over the last two decades to replace bandwidth-limited electrical interconnections between computer microprocessors and memory devices. One design, as described in Dangel, R., et. al, “Polymer-Waveguide-Based Board-Level Optical Interconnect Technology for Datacom Applications”, IEEE Transactions on Advanced Packaging, Vol 31, No. 4, November 2008, p. 759, requires the transceivers to be physically aligned with waveguides embedded in a Printer Circuit Board (PCB). This type of alignment is critical for the performance of the link, and alignment tolerances on the order of 5 um are required. These will likely be difficult to achieve over yield and temperature.

### SUMMARY

A photonic antenna is implement using a traveling wave fed, dielectric, surface wave excited, antenna array technology. More particularly, a parallel, traveling wave-fed, surface wave dielectric waveguide includes one or more excited antenna elements arranged in a line or other array. The waveguide structure is deposited on the system of antenna elements, and the photodiode detectors are deposited on the waveguide, or wafer bonded to the waveguide core. The optical sources (e.g. laser diodes, VCSELS, laser transistors) are butt coupled to the edge of the wavegude via wafer bonding or as part of a deposition process to maintain a monolithic device.

The waveguide may be implemented using SiON on SiO2, and is essentially lossless over a 3:1 spectral bandwidth. Other waveguide materials are possible as well, depending on the wavelength of interest.

The device acts as a free-space optical transceiver embodied in an integrated photonic antenna and waveguide structure, and provides high speed, spectrally broadband response. The device inherently includes an open architecture for implementing Wavelength Division Multiplexing (WDM) allowing a scalable bandwidth implementation.

One application of the photonic antenna is in a monolithic, free-space, line-of-sight optical link that can provide bistatic or monostatic communication. Wavelength division multiplexing (WDM) is accomplished via optical coatings on spatially separated photodetectors. WDM can also be accomplished by designing the structure to be dispersive and angularly directing the wavelengths to different desired locations.

The link budget using these devices is configurable, based the geometric concentration provided by the relative size of the antenna surface area to the waveguide core area in the receiver. This provides flexibility in designing the output power capability of the integral laser diode and the receiver sensitivity. Indeed, the optical photonic antenna can be designed to concentrate the incident field by 20 dB or greater, resulting in an increased signal to noise ratio, without increasing the laser power.

Such a high-efficiency, low-noise optical receiver can be used in many other applications, such as Light Detection and Ranging (LIDAR) or any size line-of-sight link application, including computer Printed Circuit Board (PCB) optical interconnects.

The dielectric traveling wave surface wave structure with scattering elements can be arranged into various types of arrays.

Wide bandwidth is achieved by optionally embedding chirped Bragg layered structures adjacent the waveguide to provide equalization of scan angle over frequency.

Existing materials and layer deposition processes are used to create this waveguide structure. The design uses low-loss surface wave modes and low-loss dielectric material which provide optimum gain performance which is key to handling power and maintaining efficiency.

The scattering features may take various forms. They may, for example, be a metal structure such as a rod formed on or in the waveguide. In other embodiments the scattering features may be one or more rectangular slots formed on or in the waveguide. In other embodiments the scattering features may be grooves formed in the top surface of the waveguide. The slot and/or grooves may have various shapes.

The scattering feature that provides leaky mode propagation may also be a continuous wedge. The wedge is preferably formed of a material having a higher dielectric constant than the waveguide.

The waveguide may be a dielectric material such as silicon nitride, silicon dioxide, magnesium fluoride, titanium dioxide or other materials suitable for leaky wave mode propagation at the desired frequency of operation.

In other embodiments, selected scattering features may be positioned orthogonally with respect to one another. This permits the antenna to operate at multiple polarizations, such as horizontal/vertical or left/right hand circular.

The scattering features can be located at each element position in an array of scattering features or may be arranged as a set of one-dimensional line arrays with the features of alternating line arrays providing different polarizations.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1-1 is a high level block diagram of a photonic antenna implemented as part of an optical communication system.

FIG. 1-2 is a high level block diagram of a line array.

FIG. 1-3 is a conceptual diagram of one implementation of the line array using rods with discrete scattering elements to operate in a leaky propagation mode.

FIG. 1-4 illustrates dispersion curves for various lengths of a dielectric rod.

FIG. 1-5 is an implementation using orthogonal surface scattering elements.

FIG. 1-6 is an example implementation of a one-dimensional line array as a dielectric substrate having surface scattering features and optional additional layers.

FIG. 1-7 is a specific embodiment as a single dielectric rod with V- and H-polarized scattering features.

FIG. 1-8 is another implementation where the leaky propagation mode is provided by a continuous wedge element.

FIG. 2 is a cross-section of a continuous element structure providing a photonic antenna transceiver set.

FIG. 3-1 illustrates a two-dimensional array implemented with multiple subarrays.

FIG. 3-2 shows how multiple sub arrays can be conFig.d to provide a square aperture LIDAR optical antenna.

FIG. 3-3 illustrates a three dimensional wedge implementation used with the two-dimensional array.

FIG. 4 shows a waveguide formed of multiple layers having a chirped spacing to provide frequency selective surfaces (FSS).

FIG. 5 illustrates the resulting equalized propagation constant.

FIG. 6 shows the fixed beam pattern along the major axis of the waveguide.

### DETAILED DESCRIPTION OF PREFERRED EMBODIMENTS

A description of example embodiments follows.

Optical Transceiver System Diagram

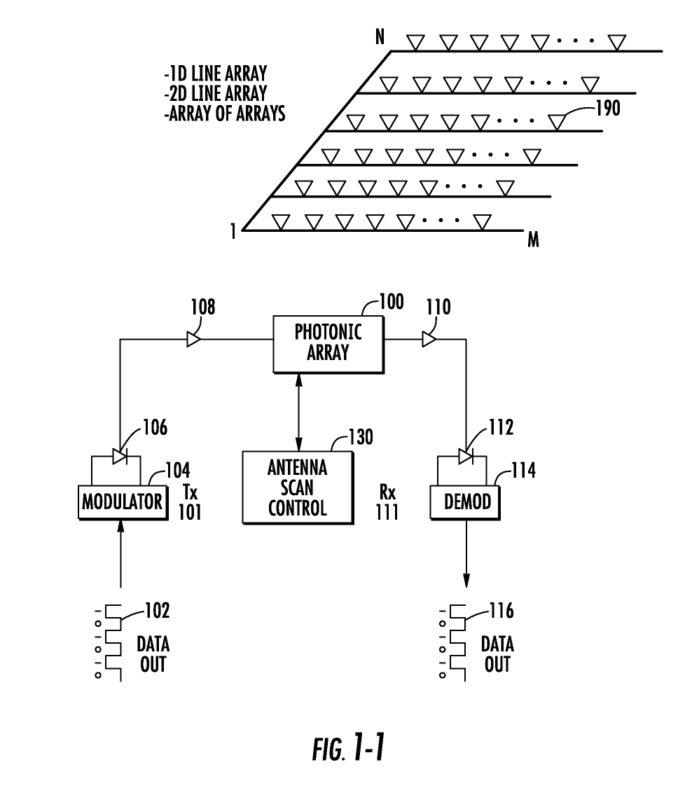

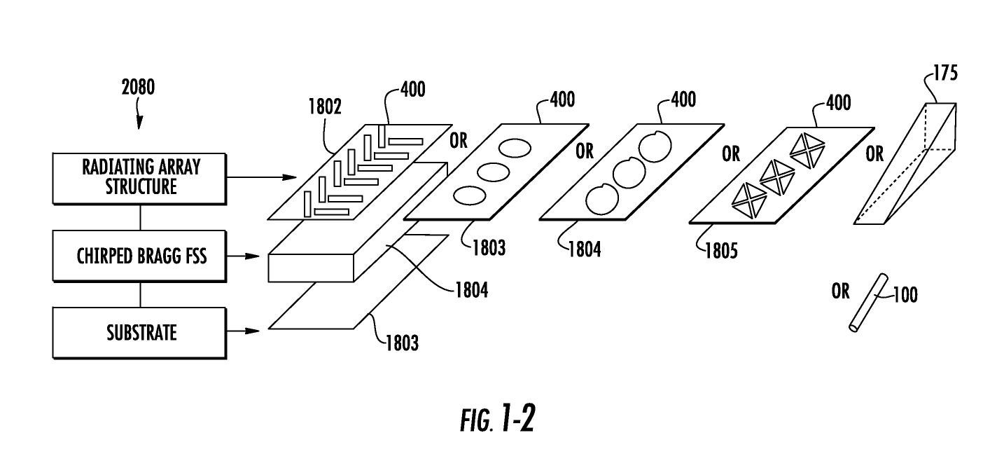

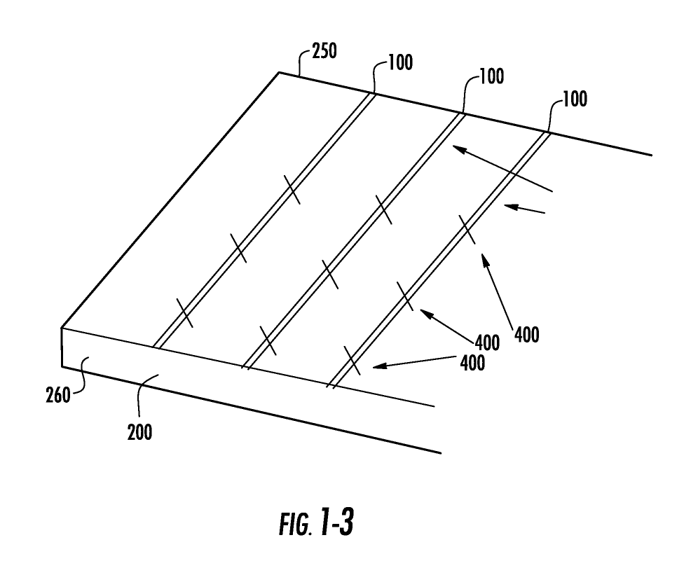

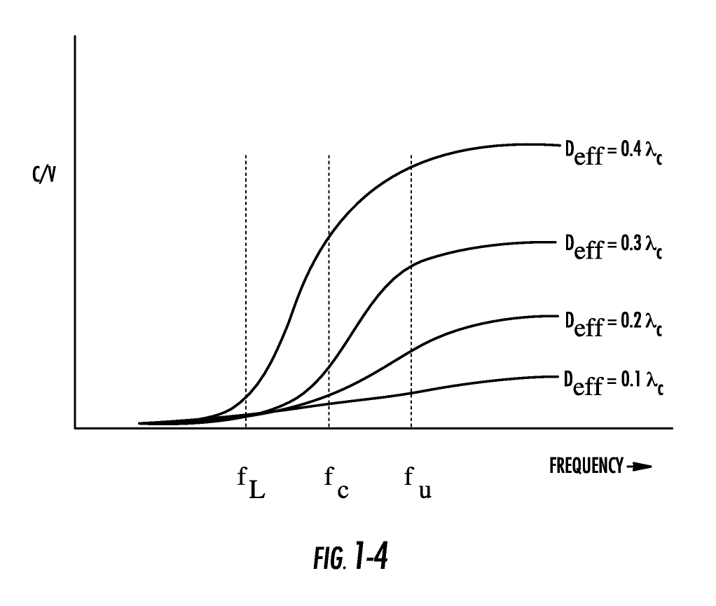

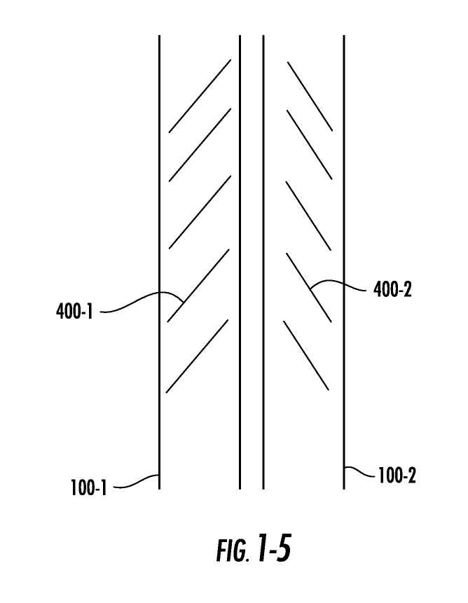

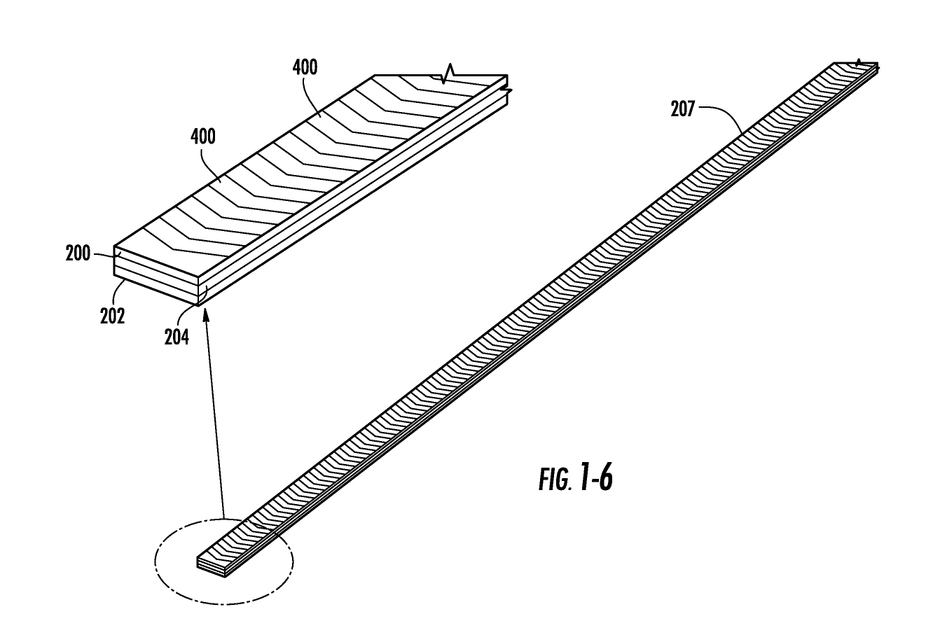

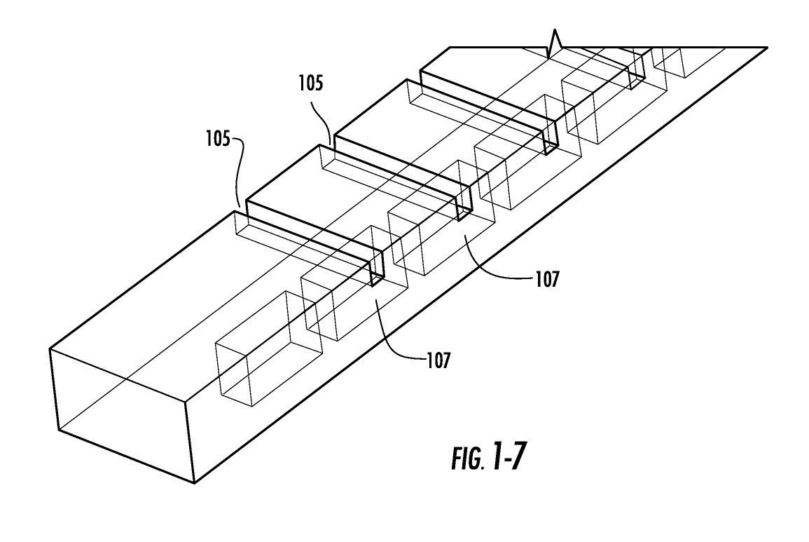

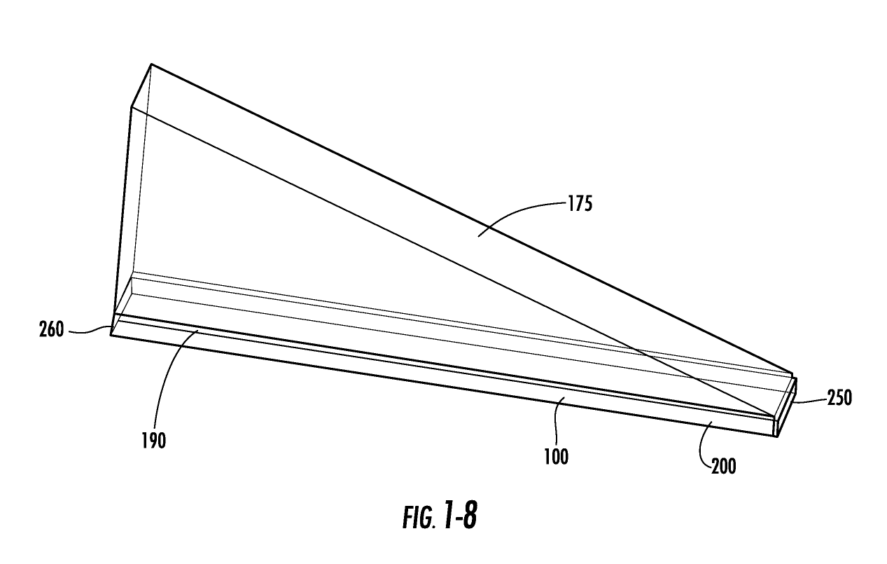

In a preferred embodiment herein as shown in FIG. 1-1, a transceiver system includes an antenna array 10. The antenna array 10 may be a line array (a linear array of elements) or it may be a two dimensional array (that is, an arrangement having N linear arrays or N×N individual elements). Transceiver provides optical signals to be transmitted by and/or received from the antenna array 100.

The transmit portion 109 of the transceiver receives an input signal 102, which may be a data signal, which is then fed to a modulator 104. An optical emitter 106 outputs a modulated light wave, which is optically amplified 108 and fed to the photonic array 100.

On the receive side 111, the photonic array 100 provides a light wave signal to a receive optical amplifier 110, and detector 112. A demodulator 114 provides an output data signal 116.

An antenna scan control block 130 may contain additional circuitry such as digital controllers to control phasing, layer spacing and other aspects of the antenna array 10 as more fully described below. A power supply, cooling and other elements typically required of such antenna array systems are also provided but not shown as they are well known.

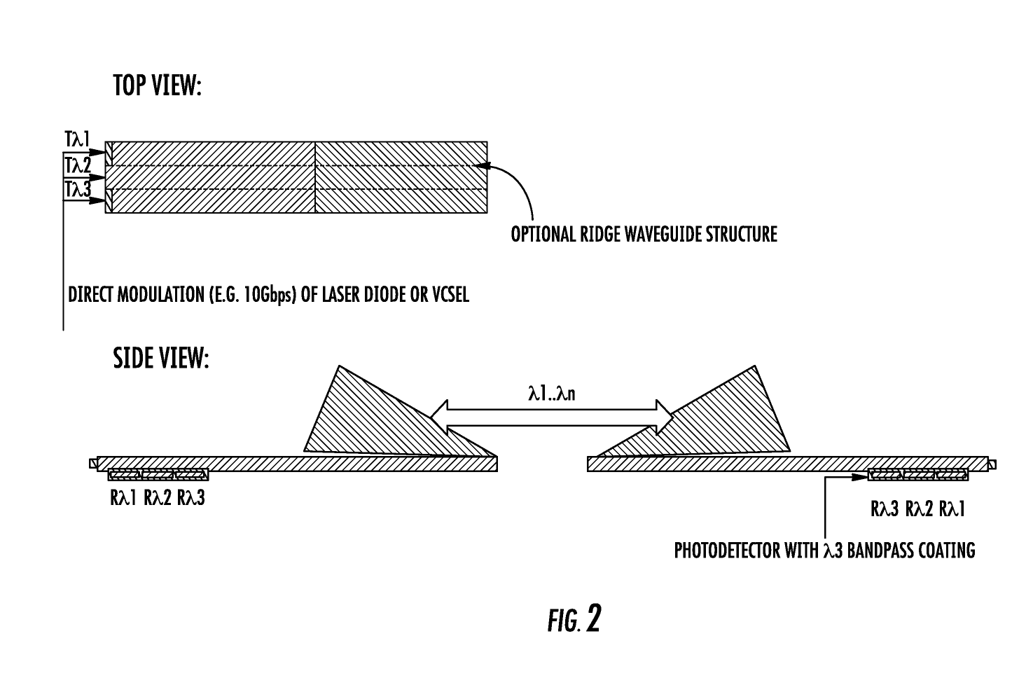

FIG. 1-2 is a general high level diagram of one embodiment of a photonic antenna array 100 implemented as one dimensional line array. The block diagram shows three (3) main structures: the Radiating Array Structure 1802 (including a collection of surface features; an optional Chirped Bragg Reflection Frequency Selective Surface (FSS) 1804; and a substrate 1803.

The proposed design concept is based on a dielectric traveling wave surface waveguide optical antenna. The surface grating structure is optimized to provide a narrow beamwidth commensurate with the intercepted area of the laser beam on a target.

The basic building block of the optical photonic array is a single dielectric traveling wave surface waveguide fed antenna line array as shown. This array building block consists of two (2) integral structures; 1) The radiating array structure which sits atop the waveguide 1802, and the optional 2) chirped Bragg reflection frequency selective surface (FSS) structure 1804. The line array is designed to create a beam normal to the surface of the aperture. The FSS implementation provides the desired bandwidth over which that beam direction is maintained. If the dispersion in the waveguide is minimized and/or the wavelength separation is small, or Wavelength Division Multiplexing (WDM) is not required, then the FSS structure 1804 can be omitted.

Certain types of surface features can be arranged as orthogonal elements 1802, adjacent Left/Right Hand Circular Polarization (L/RHCP) elements 1803, 1804, or Vertical/Horizontally polarized elements 1805.

In preferred embodiments herein, much improved efficiency is provided by a waveguide structure having surface scattering features arranged in one or more subarrays.

Single line array antennas can be used to synthesize frequency scanning beams. The array elements are excited by a traveling wave progressing along the array line. Assuming constant phase progression and constant excitation amplitude, the direction of the beam is that of Equation (1).

θ=β(line)/β−(λm)/s (1)

where s is the spacing between elements, m is the order of the beam, β (line) is the leaky mode propagation constant, and β is the free space propagation constant, and λ is the wavelength. Note the frequency dependence of the direction of the beam.

The photonic antenna uses one or more dielectric surface waveguides with one or more arrays of one-dimensional, sub-array features (also called “rods” herein). Alternately, one large panel or “slab” of dielectric substrate can house multiple line or subarrays as will be described below.

Treating each of the subarrays as a transmitting case, the rods are excited at one end and the energy travels along the waveguide. The surface elements absorb and radiate a small amount of the energy until at the end of the rod whatever power is left is absorbed by one or more resistive loads at the load end. Operation in the receive mode is the inverse.

FIG. 1-3 illustrates the general geometry of one such structure, consisting of a dielectric waveguide 200 with the leaky mode scattering elements situated on the waveguide surface. In this arrangement, the scattering elements are a set of dielectric rods 100 disposed in parallel on the waveguide and extend from a resistive load end 250 to an excitation (or feed) end 260. Each dielectric rod 100 provides a single one-dimensional sub array; sets of two or more of dielectric rods 100 together provide a two-dimensional array.

Scattering elements 400 disposed along each of the rods 100 can be provided by conductive strips formed on, grooves cut in the surface of, or grooves entirely embedded into, the dielectric. The cross section of the rods may be square or circular and the scattering elements may take many different forms as will be described in more detail below.

The surface wave mode of choice is HE11 which has an exponentially decreasing field outside the waveguide and has low loss. The direction of the resulting beam is stated in Equation 2:

Cos(b)=C/V−wavelength/S (2)

where C/V is the ratio of velocity in free space to that in the waveguide and S is the array element spacing.

The dispersion of the dielectric waveguide is shown in FIG. 1-4 for various diameters (D) of the rods 100. Fc is the center frequency of the desired band (Fu−FL). As the diameter changes from 0.1λc wavelengths to 0.4λc wavelengths, C/V in the rod increases with frequency. To scan the beam along the waveguide axis, the propagation constant of the waveguide can be changed by using a reconfigurable layered structure embedded in the waveguide as will be described below.

Line Array Implementations

As generally shown in FIG. 1-5, adjacent rods 100-1, 100-2 may have scattering features 400-1, 400-2 with alternate orientation(s) to provide orthogonal polarization (such as at 90 degrees to provide both horizontal (H) and vertical (V) polarization) or, say left and right hand circular polarization. This can maximize energy transfer in certain applications such as when the signals of interest are of known polarizations or even known to be unpolarized (randomized polarization).

FIG. 1-6 is a more detailed view of another implementation as a single line array 207, which may also be used as a building block of large two-dimensional arrays. This type of line array 207 consists of the dielectric waveguide 200 having scattering features 400 formed on the surface thereof to achieve operation in the leaky wave mode. The waveguide 200 is positioned on a substrate 202; one or more intermediate layers 204 may be disposed between the waveguide 200 and the substrate 202 as described more fully below. Sub arrays with orthogonal scattering elements can also be constructed individually. See FIG. 1-7 for an example.

Individual scattering element 400 design is dependent on the choice of construction. It suffices here to say that the scattering elements and can be provided in a number of ways, such as strips or grooves embedded into the dielectric waveguide.

Collocated elliptically polarized elements provide polarization diversity to maximize the energy captured when it is randomly polarized. In one embodiment, that shown in FIG. 1-7, surface grooves 105 are co-located and orthogonally disposed with respect to embedded areas cut-out 107 of the dielectric at each position in the line array. In this implementation, the width of the groove 105 in the upper surface of the waveguide 100 may change with position along the waveguide. If λ is the wavelength of operation of the sub array, the grove width may increment gradually, such as from λ/100 at the resistive load end 250 to λ/2 at the excitation end 260; the spacing between features may be constant, for example, λ/4.

FIG. 1-8 illustrates another way to implement leaky mode operation. Rather that individual scattering elements embedded in or on the waveguide 200, a continuous wedge structure 175 can be placed adjacent to the waveguide 200. The coupling between the waveguide 200 and the wedge 175 preferably increases as a function of distance along the waveguide 200 to facilitate constant amplitude along the radiation wave front. This may be accomplished by inserting a third layer 190 between the wedge 175 and the waveguide 200 with a decreasing thickness along the waveguide. This coupling layer 190, preferably formed of a material with yet another relative permittivity constant, ensures that the power leaked remains uniform along the length of the corresponding rod or slab.

The propagation constant in this “leaky wedge with waveguide” implementation of FIG. 1-8 determines the beam direction. To receive both horizontal and vertical polarization at a given beam direction, the propagation constants for horizontal and vertical modes of the waveguide-wedge configuration must be equal. There is a slight difference in the propagation constants for the H- and V-pol modes, which is manifested as a slight difference in the beam direction (3 degrees). The vertical beam is shifted more than the horizontal implying a slightly higher propagation constant. By applying a thin layer of high dielectric material on the bottom of the waveguide 200, the horizontal propagation constant can be increased relative to the vertical resulting in the beams coinciding.

An alternate continuous element aperture can also be implemented as shown in FIG. 2. Here, the received light is coupled evanescently from the continuous element dielectric wedge structure to the planar waveguide and again to the detector. Transmitted light sources are oriented along the planar structure and can either be mixed along that dimension if enough link margin exists, or separated spatially using a ridge waveguide structure. Although this free-space lightwave coupling has been accomplished for single wavelength lasers, it has not, to our knowledge, been implemented in a WDM scheme in conjunction with evanescent waveguide coupling to active photonic devices. Here, each optical source, which can be a VCEL or laser diode, is directly driven by an electrical modulated data source. Its modulated lightwave output gets coupled into the waveguide and evanescently coupled into the distributed dielectric aperture or prism. The design of the prism, specifically the index of refraction and angles, will be such that the output angle is parallel to the surface of the waveguide. This is accomplished when the sum of the optimally coupling input angle, θin, and the prism angle, θp, is 90□. This will allow these dielectric aperture transceivers to be mounted on the PCB in a similar fashion to other electronic chips or LEDs. The free space nature of the devices require line of sight alignment, but flexibility in electronic chip placement can be facilitated by small dielectric mirrors and/or custom prisms or wedges as is typically done for laser cavity mechanical design.

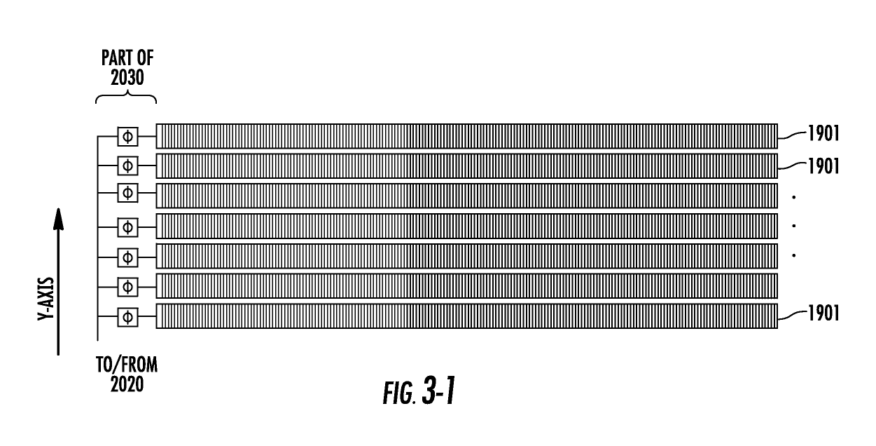

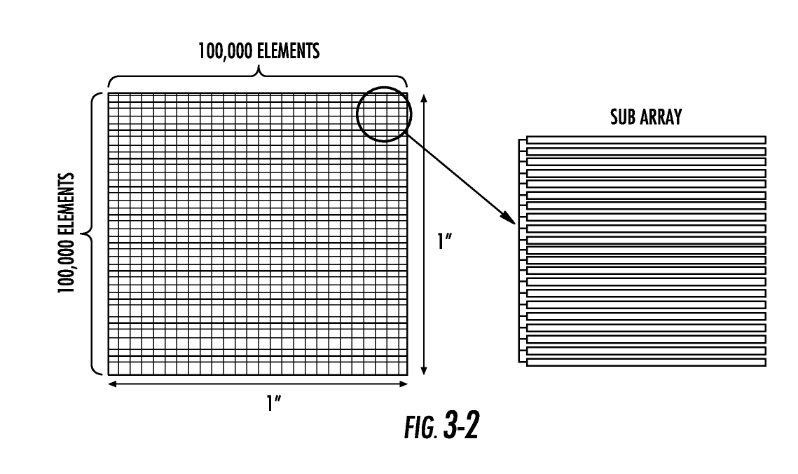

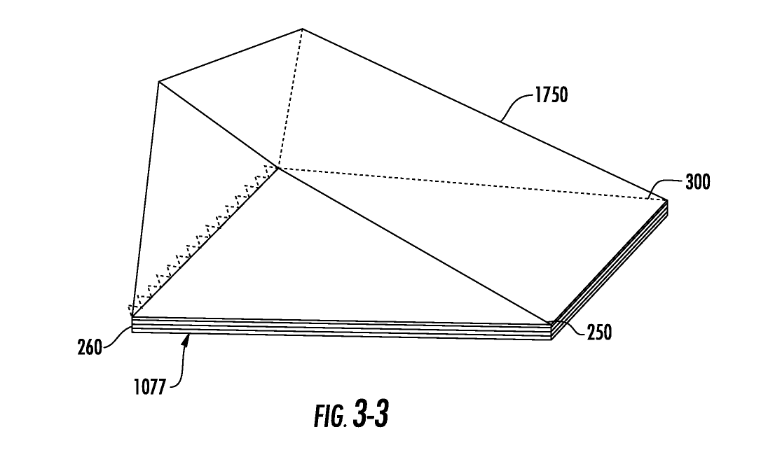

Beam steering with a single beam in the Y-Axis Field of Regard from 0° to +/−90° can be accomplished by arraying multiple waveguide antenna line arrays and applying a range of different phase shifts as shown in FIG. 3-1.

Although shown in the above figures as a line array or single element, the embodiment can easily be extended to a two dimensional array. FIG. 3-2 depicts a single output 1.0 inch square aperture consisting of 100 sub arrays of dielectric waveguide line arrays each occupying a 0.1 inch×0.1 inch area. The optical antenna aperture in conjunction with the photodetectors provide a solution that meets the ultimate goal of a device that captures energy and converts it to electrons with low-profile, high signal to noise characteristics in addition to being wide band, scalable and low-cost.

FIG. 3-3 illustrates yet another embodiment of a two dimensional photonic antenna array combining various principals as described above. In this implementation, the array consists of a slab 300. The slab 300 may have formed thereon a wedge 1750 much like the wedge described earlier in connection with FIG. 2. However, this wedge 1750 covers the surface of a two dimensional slab 300. The slab 300 extends from a feed end 260 to a load end 250 as in other embodiments.

The feed end 260 may be arranged with a single feed or may be arranged with individual multiple feeds.

Chirped Bragg Layers to Provide Broadband Operation

As mentioned above, chirped Bragg layers situated underneath the waveguide structure can alter the propagation constant of the waveguide as a function of frequency. In this way, it is possible to line up beams in the far-field, making this photonic antenna broadband.

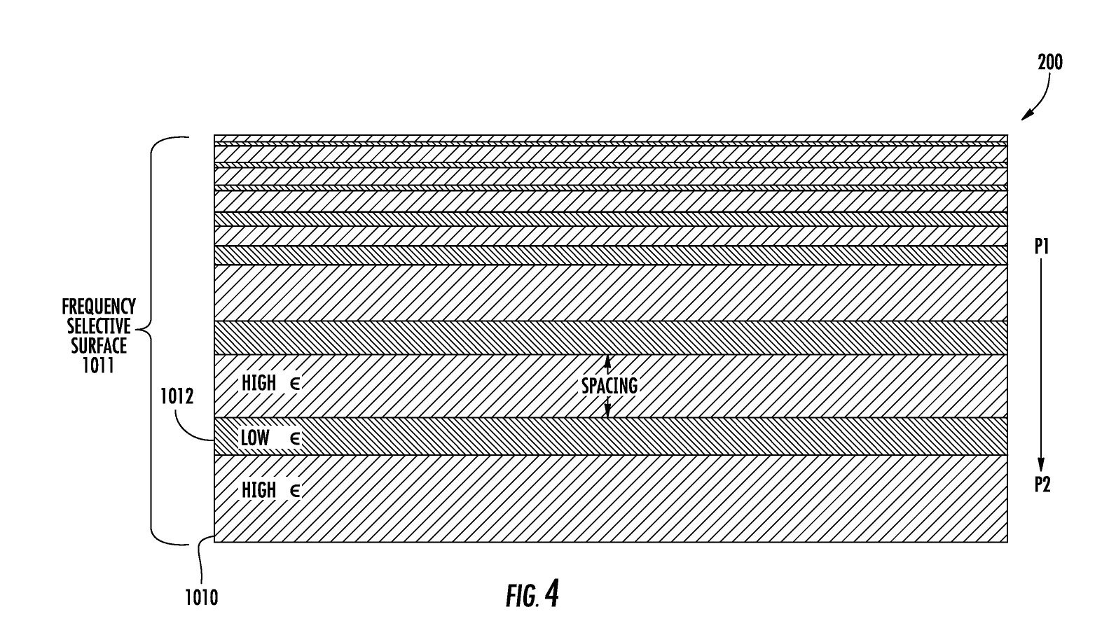

An embodiment of an apparatus using such Frequency Selective Surfaces (FSS) 1011 shown in FIG. 4. These FSS 1011, also known as chirped Bragg layers, are provided by a set of fixed layers of low dielectric constant material 1012 alternated with high dielectric constant material 1010. The spacing of the layers is such that the energy is reflected where the spacing is ¼ wavelength. The relatively higher frequencies (lower wavelengths) are reflected at layers P1 (those nearer the top surface of waveguide 100) and the lower frequencies (high wavelengths) at layers P2 (those nearer the bottom surface). The local (or specific) layer spacing as function of distance along P1 to P2 is adjusted to obtain the required propagation constant as a function of frequency to achieve wideband frequency independent beams. Equation (1) can be solved for a given beam direction to obtain the geometry of the chirped Bragg layers.

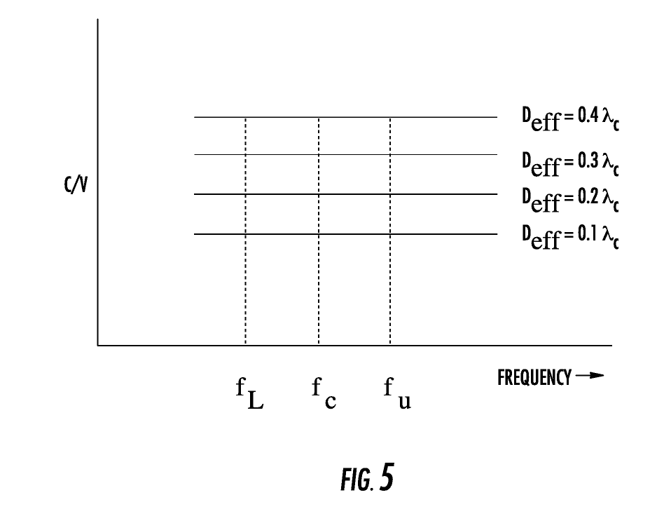

The FSS 1011 are fixed layers of low dielectric constant material alternated with high dielectric constant material. The spacing of the layers is such that the energy is reflected where the spacing is ¼ wavelength. The higher frequencies are reflected by the layer at position P1 and the lower frequencies by the layer at position P2. The local (or specific) spacing as functions of distance along P1 to P2 is adjusted to affect a wide band equalized propagation constant value. The dispersion curve of FIG. 1-4 evolves into the curve of FIG. 5, where D_{eff} is the effective rod 100 diameter controlled by the configurable gaps. A further refinement of the dispersion curve insures that the beam direction is independent of frequency. These changes are found by solving Equation (2) for each FSS layer and will result in a slight tilt in the curves of FIG. 5. It may be necessary to reduce unwanted reflections in the FSS via a double chirped and anti-reflection coating on the radiating array surface.

The elements shown above provide circular or elliptical polarization. In a LIDAR application, the actual polarization of the elements will depend upon the nature of the polarization of the LIDAR returns. In order to create this low-loss, high gain beam pattern, a line array of elements is used and is optimized in the radiating array structure of the dielectric traveling wave surface waveguide antenna. Low-loss material selection, spacing between the elements, rotation of the elements and the progressive widths of the elements are tradable design parameters which are considered in the design. The elements are implemented either as conductive elements or grooves in the dielectric, both of which are evaluated. To make certain that the beam direction is normal to the surface of the dielectric, the propagation constant and element spacing of the overall structure is considered in addition to the radiating array structure's positional relationship with respect to the chirped Bragg reflection FSS.

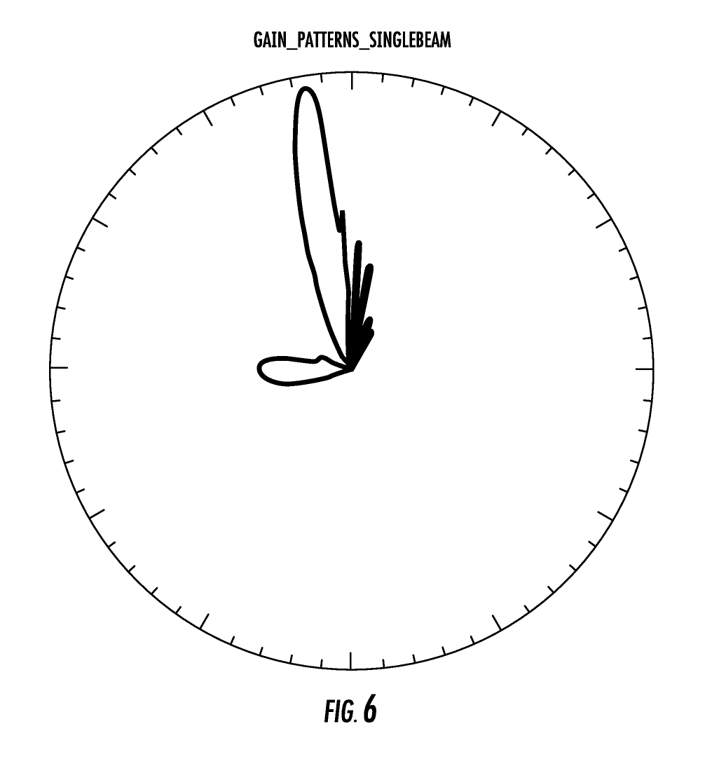

A 17 element traveling wave array was simulated where the modeled results of the pattern characteristics of the high gain fixed beam along the axis of the waveguide are shown in FIG. 6. The fixed direction of the beam is based on the volumetric makeup of the radiating array structure. The chirped Bragg reflection frequency selective surface (FSS) is the bottom structure of the dielectric traveling wave antenna which provides bandwidth enhancement so that the beam is able to sustain its pattern shape, direction and gain across a wide band.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A photonic apparatus comprising:
a travelling wave fed, surface wave excited, dielectric waveguide having a top surface; and
one or more optical scattering features disposed on the top surface of or within the waveguide and arranged in one or more line arrays.

2. The apparatus of claim 1 wherein the scattering features are a rectangular slot formed in, the waveguide.

3. The apparatus of claim 1 wherein the scattering features comprise two or more linear subarrays disposed in parallel with one another.

4. The apparatus of claim 1 wherein the scattering features are grooves formed in is the top surface of the waveguide.

5. The apparatus of claim 1 wherein the waveguide is a dielectric of a material selected from the group consisting of SiON and SiO₂.

6. The apparatus of claim 1 wherein one or more scattering features are disposed in a two dimensional array on or within the waveguide, the scattering features positioned in locations extending from one end of the waveguide to another end of the waveguide.

7. The apparatus of claim 1 additionally comprising:
a modulator, for receiving an input signal and producing a modulated light wave;
an optical emitter, for receiving a modulated light wave from the waveguide;
an optical detector, optically coupled to the waveguide, for producing a received signal; and
a demodulator, for producing a demodulated signal.

8. The apparatus of claim 7 wherein the optical modulator and optical detector produce multiple optical signals.

9. The apparatus of claim 8 wherein the multiple optical signals are wavelength division multiplex (WDM) signals using spatial and/or angle for signal separation.

10. The apparatus of claim 1 wherein the scattering feature is a continuous element dielectric wedge.

11. The apparatus of claim 1 wherein two or more optical sources of different wavelengths are disposed along a waveguide edge.

12. The apparatus of claim 1 wherein two or more optical detectors of different wavelengths are disposed along a waveguide edge.

13. An optical communication system comprising:
a modulator, for receiving an input signal and producing a modulated light wave;
an optical emitter, for receiving a modulated light wave from the waveguide and emitting an optical signal;
a first surface wave excited, dielectric waveguide having a top surface with one or more optical scattering features disposed on the top surface, for receiving the emitted optical signal and producing a transmitted optical signal;
a second surface wave excited, dielectric waveguide having a top surface with scattering features disposed on the top surface, for receiving the transmitted optical signal and producing a received optical signal;
an optical detector, optically coupled to the second dielectric waveguide, to receive the received optical signal and for producing a received signal; and
a demodulator, for producing a demodulated signal from the received signal.
